(19) United States
(12) Patent Application Publication
(10) Pub. No.: US 2025/0240679 A1
(43) Pub. Date: Jul. 24, 2025

(54) SYSTEMS AND METHODS FOR OPTIMIZING PROCESSES FOR CHANGING PRIMARY CELLS IN SECONDARY CELL GROUPS

(71) Applicant: ZTE CORPORATION, Shenzhen (CN)

(72) Inventors: Jiren HAN, Shenzhen (CN); Yin GAO, Shenzhen (CN); Dapeng LI, Shenzhen (CN); Zhuang LIU, Shenzhen (CN)

(73) Assignee: ZTE CORPORATION, Shenzhen (CN)

(21) Appl. No.: 19/046,887

(22) Filed: Feb. 6, 2025

Related U.S. Application Data
(63) Continuation of application No. PCT/CN2022/110943, filed on Aug. 8, 2022.

(51) Int. Cl. H04W 36/00

(52) U.S. Cl. CPC H04W 36/0069; H04W 36/0058; H04W 36/0079

(57) ABSTRACT

Presented are systems, methods, apparatuses, or computer-readable media for optimizing primary cell of secondary cell group (PSCell) change processes. A wireless communication device may identify a failure occurred for a procedure to change from a first PSCell in a source secondary communication node to a second PSCell in a target secondary communication node. The wireless communication device may send a first message including first information related to the failure.

### CROSS-REFERENCE TO RELATED APPLICATION

This application claims the benefit of priority under 35 U.S.C. § 120 as a continuation of PCT Patent Application No. PCT/CN2022/110943, filed on Aug. 8, 2022, the disclosure of which is incorporated herein by reference in its entirety.

### TECHNICAL FIELD

The disclosure relates generally to wireless communications, including but not limited to systems and methods for optimizing primary cells in secondary cell groups (PSCell) change processes.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for optimizing primary cell of secondary cell group (PSCell) change processes. A main communication node may receive, from a wireless communication device, a first message including first information related to a failure occurred for a procedure to change from a first PSCell in a source secondary communication node to a second PSCell in a target secondary communication node. The main communication node may send, to a source or target secondary communication node where the failure occurred, a second message including a report with second information.

In some embodiments, the first information may include at least one of: information of the first PSCell; information of a failed cell which is the first PSCell or the second PSCell; a type of the failure; a measurement on the first PSCell and/or the second PSCell; an indicator indicating whether the first and/or second PSCell being measured is a Conditional PSCell Addition and Change (CPAC) candidate PSCell; a timer associated with the failure; one or more latest received CPAC execution conditions; or a list of one or more latest configured CPAC candidate PSCells.

In some embodiments, the second information may include at least one of: a Cell Group Identity (CGI) of the first PSCell; a CGI failed cell which is the first PSCell or the second PSCell; a container further including the first information; a maximum number of PSCells to prepare; a list of candidate PSCells; or an arrival probability for the wireless communication device towards the target secondary communication node.

At least one other aspect is directed to a system, a method, an apparatus, or a computer-readable medium for optimizing primary cell of secondary cell group (PSCell) change processes. A source secondary communication node may receive, from a wireless communication device, a third message including third information related to a failure occurred for a procedure to change from a first PSCell in the source secondary communication node to a second PSCell in a target secondary communication node. The target secondary communication node may send, to a main communication node, a sixth message including a report with sixth information.

In some embodiments, the fifth information may include at least one of: information of the first PSCell; information of a failed cell which is the first PSCell; a type of the failure; a measurement on the first PSCell and/or the second PSCell; an indicator indicating whether the first and/or second PSCell being measured is a Conditional PSCell Change (CPAC) candidate PSCell; a timer associated with the failure; one or more latest received CPAC execution conditions; or a list of one or more latest configured CPAC candidate PSCells.

In some embodiments, wherein the sixth information may include at least one of: a Cell Group Identity (CGI) of the first PSCell; a CGI failed cell which is the first PSCell; a container further including the first information; a maximum number of PSCells to prepare; a list of candidate PSCells; or an arrival probability for the wireless communication device towards the target secondary communication node.

At least one other aspect is directed to a system, a method, an apparatus, or a computer-readable medium for optimizing primary cell of secondary cell group (PSCell) change processes. A wireless communication device may identify a failure occurred for a procedure to change from a first PSCell in a source secondary communication node to a second PSCell in a target secondary communication node. The wireless communication device may send a first message including first information related to the failure.

In some embodiments, the first information may include at least one of: information of the first PSCell; information of a failed cell which is the first PSCell or the second PSCell; a type of the failure; a measurement on the first PSCell and/or the second PSCell; an indicator indicating whether the first and/or second PSCell being measured is a Conditional PSCell Addition and Change (CPAC) candidate PSCell; a timer associated with the failure; one or more latest received CPAC execution conditions; or a list of one or more latest configured CPAC candidate PSCells.

In some embodiments, the wireless communication device may send, to a main communication node, the first message. In some embodiments, in response to receiving the first message, the main communication node may analyze the first information; generate a report related to the failure that includes second information; and send, to the source or target secondary communication node where the failure occurred, a second message including the report.

In some embodiments, the wireless communication device may send, to the source secondary communication node, the first message. In some embodiments, in response to receiving the first message, the source secondary communication node may analyze the first information; generate a report related to the failure that includes second information; and send, to a main communication node, a third message including the report. The report may be further sent to the target secondary communication node where the failure occurred.

In some embodiments, the wireless communication device may send, to the target secondary communication node, the first message. In some embodiments, in response to receiving the first message, the target secondary communication node may analyze the first information; generate a report related to the failure that includes second information; and send, to a main communication node, a fourth message including the report. In some embodiments, the report may be further sent to the source secondary communication node where the failure occurred.

In some embodiments, the second information may include at least one of: a Cell Group Identity (CGI) of the first PSCell; a CGI failed cell which is the first PSCell or the second PSCell; a container further including the first information; a maximum number of PSCells to prepare; a list of candidate PSCells; or an arrival probability for the wireless communication device towards the target secondary communication node

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a communication diagram of a process for generating a secondary cell group (SCG) failure information for a conditional primary cell of secondary cell group (PSCell) addition and change (CPAC) in accordance with an illustrative embodiment;

FIG. 4 illustrates a communication diagram of a process for transferring a secondary cell group (SCG) failure report between a master node (MN) and a failed secondary node (SN) in accordance with an illustrative embodiment;

FIG. 5 illustrates a communication diagram of a process for transferring a secondary cell group (SCG) failure report among a master node (MN), a source secondary node (SN), and a failed SN in accordance with an illustrative embodiment;

FIG. 6 illustrates a communication diagram of a process for transferring a secondary cell group (SCG) failure report among a master node (MN), a failed secondary node (SN), and a target SN in accordance with an illustrative embodiment; and

FIG. 7 illustrates a flow diagram of a method of optimizing primary cell of secondary cell group (PSCell) change processes in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

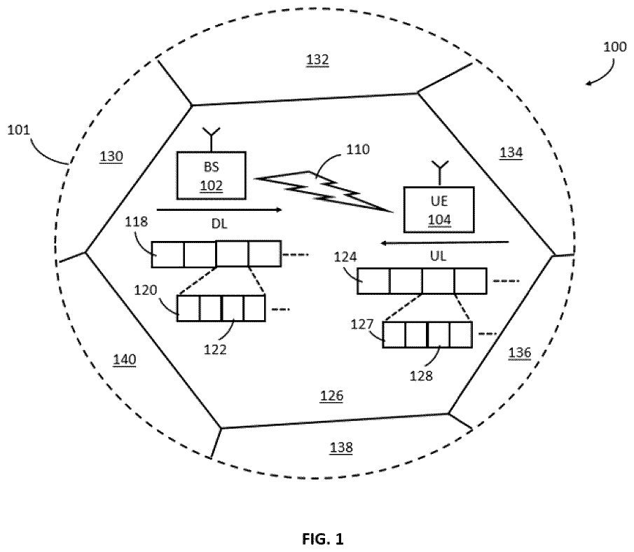

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

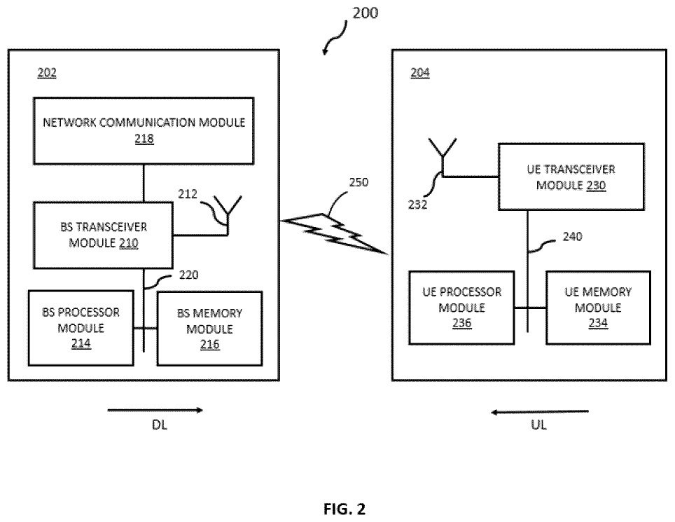

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Optimizing Primary & Secondary Cell Change Processes

The inter-secondary node (SN) conditional primary cell of secondary cell group (PSCell) change procedure may be carried out in accordance with a protocol. However, the abnormal case for this procedure cannot be identified and recovered autonomously. Presented herein are systems and methods of optimizing PSCell change processes for addressing these technical challenges.

In such settings, self-optimization networks (SON) in Long-Term Evolution (LTE) system may be used to support deployment of the system and performance optimization. Mobility Robustness Optimization (MRO) may be one of the most features in SON. MRO may aim at detecting and enabling correction of mobility related problems which will deteriorate user experience and waste network resources, such as the connection failure due to intra-radio access technology (RAT) or inter-RAT mobility, unnecessary handover to another RAT, and inter-RAT ping-pong, among others.

Multi-Radio Dual Connectivity (MR-DC) may be a generalization of the Intra-Evolved Universal Terrestrial Radio Access (E-UTRA) Dual Connectivity (DC). In E-UTRA DC, a multiple receiver and transmitter (Rx/Tx) capable user equipment (UE) may be configured to utilize resources provided by two different nodes connected via non-ideal backhaul, one providing new radio (NR) access and the other one providing either E-UTRA or NR access. One node may act as a master node (MN) and the other as the secondary node (SN). The MN and SN may be connected via a network interface and at least the MN may be connected to the core network.

A conditional PSCell Addition may be a PSCell addition procedure that is executed when PSCell addition condition(s) are met. A conditional PSCell Change may be a PSCell change procedure that is executed when PSCell execution condition(s) are met. The inter-SN conditional PSCell change may be a PSCell change procedure from the source PSCell in the Source SN to the target PSCell in the Target SN.

Regarding the PSCell change failure, the failure may be caused by the following three cases: (1) too late of a PSCell change; (2) too early of a PSCell change; or (3) change to an incorrect PSCell. Under the first case, a secondary cell group (SCG) failure may occur after the UE has stayed for a long period of time in the PSCell and a suitable different PSCell may be found based on the measurements reported from the UE. Under the second case, an SCG failure may occur shortly after a successful PSCell change from a source PSCell to a target PSCell or a PSCell change failure may occur during the PSCell change procedure. The source PSCell may still be the suitable PSCell based on the measurements reported from the UE. Under the third case, an SCG failure may occur shortly after a successful PSCell change from a source PSCell to a target PSCell or a PSCell change failure may occur during the PSCell change procedure. In this case, the suitable PSCell different with source PSCell or target PSCell may be found based on the measurements reported from the UE.

When the failure of a conditional PSCell addition and change (CPAC) procedure happens, the UE may send the SCG Failure Information to the network to indicate the failure. For the MR-DC deployment in NG-RAN network, the UE may send the SCG Failure Information to the MN. Then, the MN may analyze the received SCG Failure Information and may generate the SCG Failure Information Report to the SN where the failure occurs.

In some embodiments, the UE may send the SCG Failure Information to the source SN. Then, the Source SN may analyze the received SCG Failure Information and generate the SCG Failure Information Report to the MN, and the MN may transfer the SCG Failure Information to the failed SN (Target SN). In some embodiments, the UE may send the SCG Failure Information to the Target SN. Then the Target SN may analyze the received SCG Failure Information and may generate the SCG Failure Information Report to the MN, and the MN may transfer the SCG Failure Information to the failed SN (Source SN).

### A. Generation of SCG Failure Information for CPAC

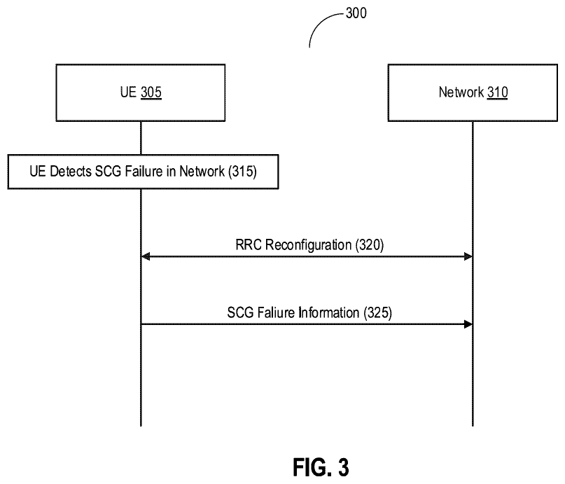

Referring now to FIG. 3, depicted is a communication diagram of a process 300 for generating a secondary cell group (SCG) failure information for a conditional primary cell of secondary cell group (PSCell) addition and change (CPAC). The process 300 may be for the generation of SCG Failure Information by the UE due to the failure of CPAC performed by a UE 305 and a network 310.

At step 315, the UE 305 may detect the SCG failure in the network. The SCG failure may be caused by the failure of CPAC procedure. At step 320, the UE 305 may trigger the radio resource control (RRC) Reconfiguration procedure between the UE 305 and the network 310 to select an appropriate next generation radio access network (NG-RAN) cell. At step 325, the UE 305 may send the SCG Failure Information to the network 310 to indicate the detailed information about the SCG failure related to CPAC.

To be more specific, the SCG Failure Information related to CPAC includes at least one of the following: information of the previous SN cell (previousPSCellId); Information of the failed SN cell (failedPSCellId); SN cause value for SCG failure (SCGFailureType), such as the CPAC failure; PSCell measurement in case of SCG failure (MeasResultSCG-Failure); Indication of whether the measured PSCell is a CPAC candidate PSCell or not; SCG Failure Timer (timeSCGFailure); latest received CPAC execution conditions; and list of the latest configured CPAC candidate PSCells, among others.

### B. SCG Failure Information Report Transfer Between MN and SN in First Scenario

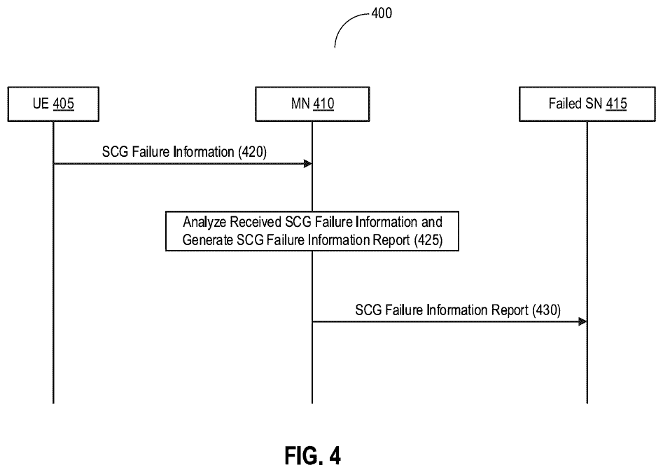

Referring now to FIG. 4, depicted is a communication diagram of a process 400 for transferring a secondary cell group (SCG) failure report between a master node (MN) and a failed secondary node (SN). For this scenario, the SCG Failure Information may be sent to the MN 410 by the UE 405, and the MN 410 may transfer the SCG Failure Information Report to the failed SN 415.

At step 420, the UE 405 may send the SCG Failure Information related to CPAC to the MN 410. To be more specific, the SCG Failure Information related to CPAC may include at least one of the following: information of the previous SN cell (previousPSCellId); information of the failed SN cell (failedPSCellId); SN cause value for SCG failure (SCGFailureType), such as the CPAC failure; PSCell measurement in case of SCG failure (MeasResultSCG-Failure); indication of whether the measured PSCell is a CPAC candidate PSCell or not; SCG Failure Timer (timeSCGFailure); latest received CPAC execution conditions; and list of the latest configured CPAC candidate PSCells, among others.

At step 425, after receiving the SCG Failure Information, the MN 410 may analyze the SCG Failure Information and generate the SCG Failure Information Report. To be more specific, the SCG Failure Information Report may include at least one of the following: source PSCell CGI (Cell Group Identity); failed PSCell CGI; SCG Failure Information Report Container (with SCG Failure Information as shown above); maximum number of PSCells to prepare; candidate PSCell List; and arrival probability for the UE towards the candidate target SN, among others.

At step 430, the MN may send the SCG Failure Information Report to the failed SN via XnAP signaling. Furthermore, the failed SN 415 may be the SN where the SCG failure occurs. To be more specific, the XnAP signaling could be one of the following: SCG FAILURE INFORMATION REPORT message; S-NODE MODIFICATION REQUEST message; and S-NODE ADDITION REQUEST message, among others. With the SCG failure Information Report, the failed SN may be able to identify the failure and recover from the failure.

### C. SCG Failure Information Report Transfer Between MN and SN in Second Scenario

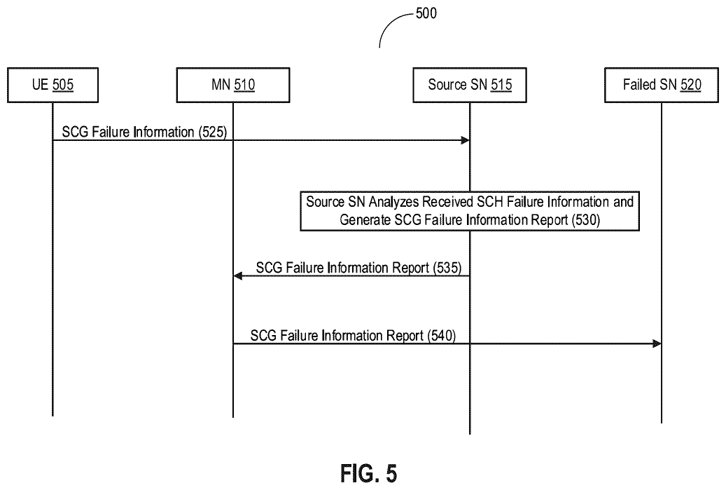

Referring now to FIG. 5, depicted is a communication diagram of a process 500 for transferring a secondary cell group (SCG) failure report among a master node (MN), a source secondary node (SN), and a failed SN. For this scenario, the SCG Failure Information may be sent to a Source SN 515 directly by the UE 505. The Source SN 515 may send the SCG Failure Information Report to the MN 510. The MN 510 may transfer the SCG Failure Information Report to the Failed SN 520. In this scenario, the SCG failure may occur in the Target SN.

Step 525, the UE 505 may send the SCG Failure Information related to CPAC to the Source SN 515. To be more specific, the SCG Failure Information related to CPAC includes at least one of the following: information of the previous SN cell (previousPSCellId); information of the failed SN cell (failedPSCellId); SN cause value for SCG failure (SCGFailureType), such as the CPAC failure; PSCell measurement in case of SCG failure (MeasResultSCG-Failure); indication of whether the measured PSCell is a CPAC candidate PSCell or not; SCG Failure Timer (timeSCGFailure); latest received CPAC execution conditions; and list of the latest configured CPAC candidate PSCells, among others.

At step 530, after receiving the SCG Failure Information, the Source SN 515 may analyze the SCG Failure Information and generate the SCG Failure Information Report. To be more specific, the SCG Failure Information Report may include at least one of the following: source PSCell CGI (Cell Group Identity); failed PSCell CGI; SCG Failure Information Report Container (with SCG Failure Information as shown above); maximum number of PSCells to prepare; candidate PSCell List; and arrival Probability for the UE towards the candidate target SN, among others.

At step 535, the source SN 515 may send the SCG Failure Information Report to the MN 510 via XnAP signaling. To be more specific, the XnAP signaling could be one of the following: S-NODE MODIFICATION REQUIRED message; S-NODE CHANGE REQUIRED message; and SCG FAILURE TRANSFER message, among others. At step 540, At step 540, the MN 510 may transfer the SCG Failure Information Report to the failed SN 520. With the SCG failure Information Report, the failed SN 520 may be able to identify the failure and recover from the failure.

### D. SCG Failure Information Report Transfer Between MN and SN (Scenario 3)

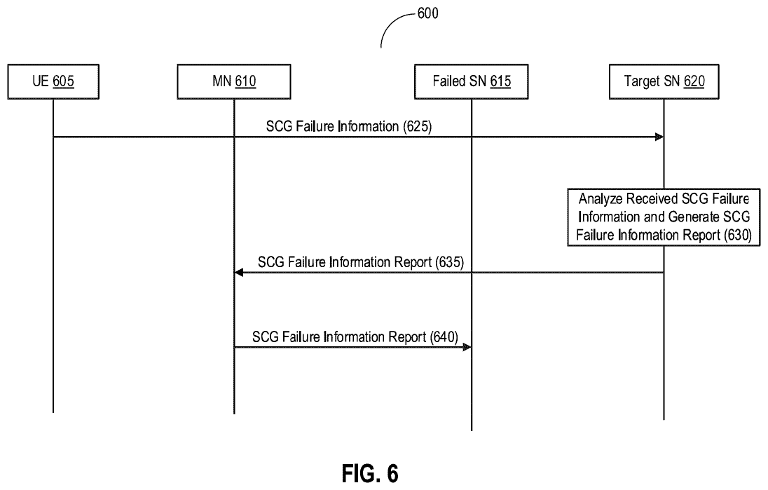

Referring now to FIG. 6, depicted is a communication diagram of a process 600 for transferring a secondary cell group (SCG) failure report among a master node (MN), a failed secondary node (SN), and a target SN. For this scenario, the SCG Failure Information may be sent to the Target SN 620 directly by the UE 605. The Target SN 620 may send the SCG Failure Information Report to the MN 610. The MN 610 may transfer the SCG Failure Information Report to the Failed SN 615. In this scenario, the SCG failure may occur in the Source SN.

At step 625, the UE 605 may send the SCG Failure Information related to CPAC to the Target SN 620. To be more specific, the SCG Failure Information related to CPAC may include at least one of the following: Information of the previous SN cell (previousPSCellId); information of the failed SN cell (failedPSCellId); SN cause value for SCG failure (SCGFailureType), such as the CPAC failure; PSCell measurement in case of SCG failure (MeasResultSCG-Failure); indication of whether the measured PSCell is a CPAC candidate PSCell or not; SCG Failure Timer (timeSCGFailure); latest received CPAC execution conditions; and list of the latest configured CPAC candidate PSCells, among others.

At step 630, after receiving the SCG Failure Information, the Target SN 620 may analyze the SCG Failure Information and generate the SCG Failure Information Report. To be more specific, the SCG Failure Information Report may include at least one of the following: source PSCell CGI (Cell Group Identity); failed PSCell CGI; SCG Failure Information Report Container (with SCG Failure Information as shown above); maximum number of PSCells to prepare; candidate PSCell List; and arrival probability for the UE towards the candidate target SN, among others.

At step 635, the Target SN 620 may send the SCG Failure Information Report to the MN 610 via XnAP signaling. To be more specific, the XnAP signaling could be one of the following: S-NODE MODIFICATION REQUIRED message; S-NODE CHANGE REQUIRED message; and SCG FAILURE TRANSFER message, among others.

At step 640, the MN 610 may transfer the SCG Failure Information Report to the failed SN 615. With the SCG failure Information Report, the failed SN may be able to identify the failure and recover from the failure.

In summary, the UE may send the SCG Failure Information related to CPAC to the MN. Then, the MN may analyze the received SCG Failure Information and generate the SCG Failure Information Report to the SN where the failure occurs. In some embodiments, the UE may send the SCG Failure Information related to CPAC to the source SN. Then, the Source SN may analyze the received SCG Failure Information and generate the SCG Failure Information Report to the MN, and the MN may transfer the SCG Failure Information to the failed SN (Target SN). In some embodiments, the UE could send the SCG Failure Information related to CPAC to the Target SN. Then the Target SN analyzes the received SCG Failure Information and generates the SCG Failure Information Report to the MN, and the MN transfers the SCG Failure Information to the failed SN (Source SN).

Generally, the SCG Failure Information related to CPAC may include at least one of the following: information of the previous SN cell (previousPSCellId); information of the failed SN cell (failedPSCellId); SN cause value for SCG failure (SCGFailureType), such as the CPAC failure; PSCell measurement in case of SCG failure (MeasResultSCG-Failure); indication of whether the measured PSCell is a CPAC candidate PSCell or not; SCG Failure Timer (timeSCGFailure); latest received CPAC execution conditions; and list of the latest configured CPAC candidate PSCells, among others.

Furthermore, the SCG Failure Information Report may include at least one of the following: source PSCell CGI (Cell Group Identity); failed PSCell CGI; SCG Failure Information Report Container (with SCG Failure Information as shown above); maximum number of PSCells to prepare; candidate PSCell List; and arrival probability for the UE towards the candidate target SN, among others.

### E. Method of Optimizing Primary Cell in Secondary Cell Group (PSCells) Change Processes

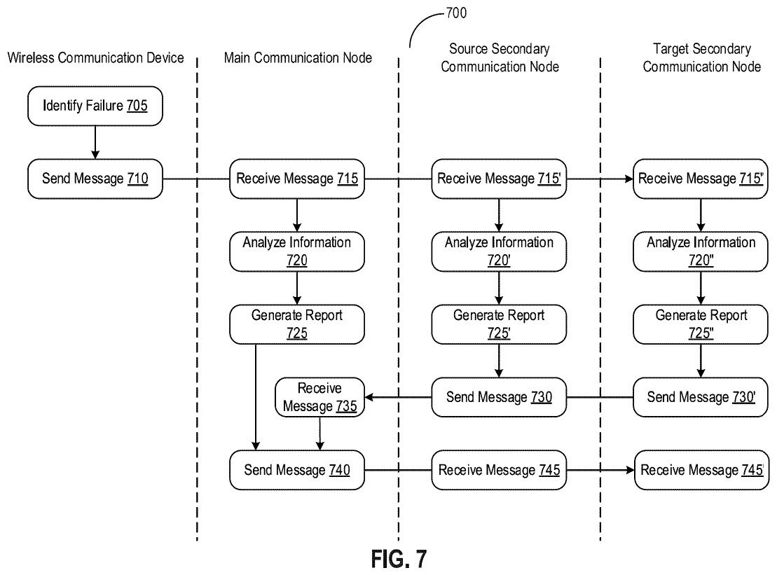

Referring now to FIG. 7, depicted is a flow diagram of a method 700 of optimizing primary cell of a secondary cell group (PSCell) change processes. The method 700 may be implemented by or performed using any of the components described herein above, such as the UE 104 or 204 or BS 102 or 202, among others. Under the method 700, a wireless communication device may identify a failure (705). The wireless communication device may send a message (710). A main communication node, a source secondary communication node, a target secondary communication node may receive the message (715, 715′, or 715″). The main communication node, the source secondary communication node, or target secondary communication node may analyze the information (720, 720′, or 720″). The main communication node, the source secondary node, or the target secondary communication node may generate a report (725, 725′, or 725″). The source secondary communication node or the target secondary communication node may send a message (730 or 730′). The main communication node may receive the message (735). The main communication node may send the message (740). The target secondary communication node may receive the message (745).

In further detail, a wireless communication device (e.g., UE 104 or 204) may sense, detect, or otherwise identify a failure (705). The failure may have occurred for a procedure to change from a first primary cell of secondary cell group (PSCell) in a source secondary communication node (e.g., BS 102 or 202) to a second PSCell in a target secondary communication node (e.g., BS 102 or 202). The failure with the PSCell change may be from: (1) a secondary cell group (SCG) failure occurring after the wireless communication device has stayed for a long time in the PSCell; (2) the SCG failure occurring after a successful PSCell change from a source PSCell to a target PSCell; (3) a PSCell change failure occurring during the PSCell change process itself; (4) an SCG failure occurs shortly after a successful PSCell change from a source PSCell to a target PSCell; or (5) a PSCell change failure occurring during the PSCell change procedure, among others. Upon detection of the failure, the wireless communication device may instrument the PSCell to acquire, derive, or otherwise generate information about the information.

The wireless communication device may provide, transmit, or otherwise send a message including information about the failure (710). In some embodiments, the wireless communication may send the message to a main communication node (e.g., BS 102 or 202). In some embodiments, the wireless communication device may send the message to the source secondary communication node. In some embodiments, the wireless communication device may send the message to the target secondary communication node. The information about the failure may identify or include: information of the first PSCell; information of a failed cell which is the first PSCell or the second PSCell; a type of the failure; a measurement on the first PSCell and/or the second PSCell; an indicator indicating whether the first and/or second PSCell being measured is a Conditional PSCell Addition and Change (CPAC) candidate PSCell; a timer associated with the failure; one or more latest received CPAC execution conditions; or a list of one or more latest configured CPAC candidate PSCells, among others.

The main communication node may retrieve, identify, or receive the message including the information related to the failure from the wireless communication device (715). The wireless communication device may have sent the message to the wireless communication node, instead of the source secondary communication node or the source secondary communication node. The source secondary communication node may retrieve, identify, or receive the message including the information related to the failure from the wireless communication device (715′). The wireless communication device may have sent the message to the source secondary communication node, instead of the main communication node or the target secondary communication node. The target secondary communication node may retrieve, identify, or receive the message including the information related to the failure from the wireless communication device (715″). The wireless communication device may have sent the message to the target secondary communication node, instead of the main communication node or the source secondary communication node.

The main communication node may evaluate, process, or otherwise analyze the information related to the failure in the message (720). The analysis of the information by the wireless communication node may be in response to receipt of the message from the wireless communication device. To analyze, the main communication node may parse the information in the message and process the information. Based on the information, the main communication node may identify or determine that one of the source secondary communication node or the target secondary communication node is where the failure with the PSCell change occurred. From analyzing the information, the main communication node may produce, output, or otherwise generate a report related to the failure (725). When the source secondary communication node is identified as where the failure occurred, the main communication node may determine to send a message including the report to the source secondary communication node. Otherwise, when the target secondary communication node is identified as where the failure occurred, the main communication node may determine to send a message including the report to the target secondary communication node.

The source secondary communication node may evaluate, process, or otherwise analyze the information related to the failure in the message (720′). The analysis of the information by the wireless communication node may be in response to receipt of the message from the wireless communication device. To analyze, the source secondary communication node may parse the information in the message and process the information. Based on the information, the source secondary communication node may identify or determine that the target secondary communication node is where the failure with the PSCell change occurred. From analyzing the information, the source secondary communication node may produce, output, or otherwise generate a report related to the failure (725′). The source secondary communication node may provide, transmit, or otherwise send a message including the report to the main communication node (730).

The target secondary communication node may evaluate, process, or otherwise analyze the information related to the failure in the message (720′). The analysis of the information by the wireless communication node may be in response to receipt of the message from the wireless communication device. To analyze, the target secondary communication node may parse the information in the message and process the information. Based on the information, the target secondary communication node may identify or determine that the source secondary communication node is where the failure with the PSCell change occurred. From analyzing the information, the target secondary communication node may produce, output, or otherwise generate a report related to the failure (725′). The target secondary communication node may provide, transmit, or otherwise send a message including the report to the main communication node (730′).

The report may include information generated (e.g., by the main wireless communication node, the source secondary communication node, or the target secondary communication node) from analyzing the information may identify or include: a Cell Group Identity (CGI) of the first PSCell; a CGI failed cell which is the first PSCell or the second PSCell; a container further including the first information; a maximum number of PSCells to prepare; a list of candidate PSCells; or an arrival probability for the wireless communication device towards the target secondary communication node, among others.

The main communication node may retrieve, identify, or otherwise receive the message from the source secondary communication node or the target secondary communication node (735). Upon receipt, the main communication node may parse the message to extract or identify the report related to the fault including the information. From the information, the main communication node may identify or determine that one of the source secondary communication node or the target secondary communication node is where the failure with the PSCell change occurred. When the source secondary communication node is identified as where the failure occurred, the main communication node may determine to send a message including the report to the source secondary communication node. Otherwise, when the target secondary communication node is identified as where the failure occurred, the main communication node may determine to send a message including the report to the target secondary communication node.

The main communication node may provide, transmit, or otherwise send a message to the source secondary communication node or the target secondary communication node (740). The message may include a report with the information from analyzing the information related to the failure. If the determination is to send the message to the source secondary communication node, the main communication node may send the message including the report from the target secondary communication node to the source secondary communication node. The source secondary communication node may in turn retrieve, identify, or otherwise receive the message from the main communication node (745). If the determination is to send the message to the target secondary communication node, the main communication node may send the message including the report from the source secondary communication node to the target secondary communication node. The target secondary communication node may in turn retrieve, identify, or otherwise receive the message from the main communication node (745′).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
receiving, by a main communication node from a wireless communication device, a first message including first information related to a failure occurred for a procedure to change from a first PSCell in a source secondary communication node to a second PSCell in a target secondary communication node; and
sending, by the main communication node to a source or target secondary communication node where the failure occurred, a second message including a report with second information.

2. The wireless communication method of claim 1, wherein the first information includes at least one of:
information of the first PSCell;
a type of the failure;
a measurement on at least one of: the first PSCell or the second PSCell; or
a timer associated with the failure.

3. The wireless communication method of claim 1, wherein the second information includes at least one of:
a Cell Group Identity (CGI) of the first PSCell;
a CGI failed cell which is the first PSCell or the second PSCell;
a container including the first information; or
a list of candidate PSCells.

4. A wireless communication method, comprising:
transmitting, by a wireless communication device to a main communication node, a first message including first information related to a failure occurred for a procedure to change from a first PSCell in a source secondary communication node to a second PSCell in a target secondary communication node; and
causing the main communication node to transmit to a source or target secondary communication node where the failure occurred, a second message including a report with second information.

5. The wireless communication method of claim 4, wherein the first information includes at least one of:
information of the first PSCell;
a type of the failure;
a measurement on at least one of: the first PSCell or the second PSCell; or
a timer associated with the failure.

6. The wireless communication method of claim 4, wherein the second information includes at least one of:
a Cell Group Identity (CGI) of the first PSCell;
a CGI failed cell which is the first PSCell or the second PSCell;
a container including the first information; or
a list of candidate PSCells.

7. A wireless communication device, comprising:
at least one processor configured to:
transmit, via a transmitter to a main communication node, a first message including first information related to a failure occurred for a procedure to change from a first PSCell in a source secondary communication node to a second PSCell in a target secondary communication node; and
cause the main communication node to transmit to a source or target secondary communication node where the failure occurred, a second message including a report with second information.

8. The wireless communication device of claim 7, wherein the first information includes at least one of:
information of the first PSCell;
a type of the failure;
a measurement on at least one of: the first PSCell or the second PSCell; or
a timer associated with the failure.

9. The wireless communication device of claim 7, wherein the second information includes at least one of:
a Cell Group Identity (CGI) of the first PSCell;
a CGI failed cell which is the first PSCell or the second PSCell;
a container including the first information; or
a list of candidate PSCells.

10. A main communication node, comprising:
at least one processor configured to:
receive, via a transceiver from a wireless communication device, a first message including first information related to a failure occurred for a procedure to change from a first PSCell in a source secondary communication node to a second PSCell in a target secondary communication node; and
send, via the transceiver to a source or target secondary communication node where the failure occurred, a second message including a report with second information.

11. The main communication node of claim 10, wherein the first information includes at least one of:
information of the first PSCell;
a type of the failure;
a measurement on at least one of: the first PSCell or the second PSCell; or
a timer associated with the failure.

12. The main communication node of claim 10, wherein the second information includes at least one of:
a Cell Group Identity (CGI) of the first PSCell;
a CGI failed cell which is the first PSCell or the second PSCell;
a container including the first information; or
a list of candidate PSCells.
